(19) United States
(12) Patent Application Publication
(10) Pub. No.: US 2010/0134069 A1
(43) Pub. Date: Jun. 3, 2010

(54) BATTERY SYSTEM WITH PRACTICAL VOLTAGE DETECTION

(76) Inventors: Takeshi OOSAWA, Ashikaga City (JP); Kimihiko Furukawa, Kakogawa City (JP)

Correspondence Address: Wenderoth,Lind & Ponack,L.L.P., 1030 Fifthteeth Street N.W, Suite 400 east, Washington, DC, 20005, US

(21) Appl. No.: 12/623,809

(22) Filed: Nov. 23, 2009

(30) Foreign Application Priority Data
Nov. 26, 2008 (JP) 2008-301744

(51) Int. Cl. H02J 7/00

(52) U.S. Cl. 320/118

(57) ABSTRACT

The battery system has a battery 1 having a plurality of series-connected battery cells 2, a voltage detection circuit 3 that detects each battery cell voltage, discharge circuits 4 to discharge each battery cell, and a decision circuit 5 that judges the condition of the connection between a battery cell 2 and the voltage detection circuit 3 from the detected battery cell voltage measured by the voltage detection circuit. The voltage detection circuit 3 measures discharge voltage of a battery cell 2 with the discharge circuit 4 in the discharging state, and measures non-discharge voltage with the battery cell 2 in a non-discharging state. The decision circuit 5 compares the difference between the detected battery cell non-discharge voltage and discharge voltage with the normal voltage, or compares battery cell discharge voltage with the normal voltage to judge abnormal connection between the battery cell and the voltage detection circuit.

### BACKGROUND OF THE INVENTION

1. Field of the Invention

The present invention relates to a battery system optimized for use as a car power source apparatus that supplies power to a motor that drives the vehicle.

2. Description of the Related Art

A battery system having many series-connected rechargeable battery cells, such as lithium ion batteries, detects the voltage of each battery cell to control battery charging and discharging. This is because prevention of over-charging and over-discharging allows battery cell lifetime to be extended while safely charging and discharging the battery cells. For a battery system having a plurality of battery cells connected in series, although each battery cell is charged and discharged with the same current, the voltage and remaining capacity of all battery cells cannot be maintained equal because of battery cell electrical characteristics are not uniform. Battery cell voltage and remaining capacity imbalance results in over-charging or over-discharging of certain battery cells. This condition causes significant degradation of the over-charged or over-discharged battery cells. This is because over-charging and over-discharging cause remarkable degradation in battery cell electrical characteristics. Further, battery cell voltage rise due to over-charging is also a cause of reduced battery safety. Therefore, in a battery system such as a car power source apparatus that connects many battery cells in series to increase output voltage, battery cell voltage is detected and voltage imbalance is corrected. (Refer to Japanese Patent Application Disclosure 2004-266992.)

As cited in Japanese Patent Application Disclosure 2004-266992, a battery system that detects battery cell voltage and discharges high voltage battery cells to correct voltage imbalance can prevent over-charging or over-discharging of certain battery cells and safely extend battery lifetime. However, if the voltage detection circuit that detects battery cell voltage becomes unable to properly measure battery cell voltage, battery cell voltage imbalance cannot be corrected. Since the input-side of the voltage detection circuit is connected to battery cell electrode terminals by wire-leads, it is possible for contact resistance to become large at wire-lead connecting regions. This contact resistance is connected in series with the input-side of the voltage detection circuit, and reduces battery cell voltage input to the voltage detection circuit. Consequently, as contact resistance increases, the battery cell voltage input to the voltage detection circuit becomes abnormal. The amount of voltage detection error induced by contact resistance is determined by the ratio of the contact resistance to the voltage detection circuit input impedance. If contact resistance is sufficiently small with respect to the input impedance, battery cell voltage can be accurately detected. As contact resistance increases relative to the input impedance, detection error increases. Consequently, detection error due to contact resistance can be reduced by increasing the input impedance of the voltage detection circuit. However, if voltage detection circuit input impedance is made large, the circuit becomes easily affected by noise, and it becomes difficult to accurately measure battery cell voltage.

For example, in a battery system with lithium ion battery cells, it is important to equalize battery cell voltages with a high degree of accuracy. To achieve this, the voltage of each battery cell must be measured with an extremely high degree of accuracy. Therefore, detection error due to even a small amount of contact resistance can be a cause of battery cell degradation.

Further, since an increase in contact resistance lowers the detected voltage of a battery cell, a battery cell with increased voltage that requires discharge is measured to have a low voltage and is not discharged. This situation becomes more critical as contact resistance increases. Since this is a condition where an over-charged battery cell with high voltage cannot be discharged, it is a cause of reduced battery system safety.

Further, although detection error due to wire-lead contact resistance can be reduced by increasing the input impedance of the voltage detection circuit, degradation of the input isolation resistance of a high input impedance voltage detection circuit can also be the cause of voltage detection error. This is because reduced isolation resistance lowers the battery cell input voltage. Consequently, when the input-side isolation resistance of the voltage detection circuit decreases, battery cell voltage cannot be accurately measured. Since a decrease in isolation resistance reduces the detected voltage of a battery cell, it becomes impossible to discharge a high voltage battery cell with a tendency to over-charge, and this also is a cause of reduced battery system safety.

The present invention was developed with the object of correcting the drawbacks described above. Thus, it is an important object of the present invention to provide a battery system that can judge whether or not the voltage detection circuit can accurately measure battery cell voltage, and can accurately measure battery cell voltage via a voltage detection circuit confirmed to operate properly.

### SUMMARY OF THE INVENTION

The first battery system of the present invention is provided with a battery 1 having a plurality of series-connected battery cells 2 that can be recharged, a voltage detection circuit 3 that detects the voltage of each battery cell 2, discharge circuits 4 connected to the battery cells 2 to discharge each battery cell 2, and a decision circuit 5 that judges the condition of the connection between a battery cell 2 and the voltage detection circuit 3 from the detected battery cell 2 voltage measured by the voltage detection circuit 3. The voltage detection circuit 3 of the battery system measures discharge voltage of a battery cell 2 with the discharge circuit 4 in the discharging state, and it measures non-discharge voltage with the battery cell 2 in a non-discharging state. The decision circuit 5 compares the difference between the detected non-discharge and discharge voltages of a battery cell 2 with the normal voltage, or it compares battery cell 2 discharge voltage with the normal voltage to judge the condition of the connection between the battery cell 2 and the voltage detection circuit 3.

The battery system described above has the characteristic that it can judge via the decision circuit whether or not the voltage detection circuit can accurately measure battery cell voltage, and it can accurately measure battery cell voltage with a voltage detection circuit confirmed to operate properly. This is because the decision circuit can detect abnormal connection between a battery cell and the voltage detection circuit from battery cell discharge voltage or from the difference between battery cell non-discharge voltage and discharge voltage.

The above and further objects of the present invention as well as the features thereof will become more apparent from the following detailed description to be made in conjunction with the accompanying drawings.

### BRIEF DESCRIPTION OF THE DRAWINGS

FIG. 1 is a circuit diagram of a battery system for an embodiment of the present invention;

FIG. 2 is a circuit diagram showing the occurrence of contact resistance in the battery system shown in FIG. 1;

FIG. 3 is a circuit diagram of a battery system for another embodiment of the present invention;

FIG. 4 is a circuit diagram showing the occurrence of leakage current in the battery system shown in FIG. 3.

### DETAILED DESCRIPTION OF THE EMBODIMENT(S)

The discharge circuits 4 of the battery system can form an equalizing circuit 7 that corrects voltage imbalance in the series-connected battery cells 2. In this battery system, since the equalizing circuit is used to determine whether or not battery cell voltage is correctly input to the voltage detection circuit, it is unnecessary to provide a special-purpose discharging circuit just to measure battery cell discharge voltage. Consequently, abnormal connection between a battery cell and the voltage detection circuit can be detected with a simple circuit structure.

Each discharge circuit 4 of the battery system can be provided with a series-connected discharge resistor 15 and discharge switch 16.

The decision circuit 5 of the battery system can control the discharge switches 16 of the discharge circuits 4 to detect battery cell 2 discharge voltage. In this battery system, since the discharge switches are controlled by the decision circuit, whether or not the voltage detection circuit operates properly can be detected with optimal timing. For example, in a battery system used as a car power source apparatus, when the ignition switch is turned ON, the decision circuit can switch ON discharge switches to detect discharge voltage. In this case, each time the ignition switch is turned ON, voltage detection circuit operation can be checked for proper operation.

The battery system is provided with a battery 1 having a plurality of series-connected battery cells 2 that can be recharged, a voltage detection circuit 3 that detects the voltage of each battery cell 2, discharge circuits 4 connected to the battery cells 2 to discharge each battery cell 2 with a series-connected discharge resistor 15 and discharge switch 16, constant voltage circuits 30 connected in parallel with the discharge resistor 15 of each discharge circuit 4, and a decision circuit 35 that detects the condition of the connection between a battery cell 2 and the voltage detection circuit 3 and the leakage current of the input-side of the voltage detection circuit 3 from the detected battery cell 2 voltage measured by the voltage detection circuit 3. In this battery system, discharge voltage of a battery cell 2 is measured with a discharge switch 16 in the ON state. The decision circuit 35 detects abnormal connection between the battery cell 2 and the voltage detection circuit 3, and detects voltage detection circuit 3 input-side leakage current from the measured discharge voltage.

The battery system described above has the characteristic that it can judge via the decision circuit whether or not the voltage detection circuit can accurately measure battery cell voltage, and it can accurately measure battery cell voltage with a voltage detection circuit confirmed to operate properly. This is because the decision circuit can detect abnormal connection between a battery cell and the voltage detection circuit, and it can also detect voltage detection circuit input-side leakage current from the battery cell discharge voltage. In particular, this battery system has the characteristic that in addition to detecting abnormal connection between a battery cell and the voltage detection circuit, voltage detection circuit input-side leakage current is also detected allowing confirmation of proper voltage detection circuit operation and accurate battery cell voltage detection.

The judgment criterion of the decision circuit 35 of the battery system can be battery cell 2 discharge voltage detected by the voltage detection circuit 3 that is outside a prescribed range of stabilized constant voltage circuit 30 voltages. This battery system can simply and reliably detect abnormal connection between a battery cell and the voltage detection circuit, and voltage detection circuit input-side leakage current.

In the battery system, each constant voltage circuit 30 can have a series resistor 31 that connects the battery cell 2 to the voltage detection circuit 3, a series circuit of the series resistor 31 and a zener diode 32, and this series circuit can be connected in parallel with the discharge resistor 15. The voltage detection circuit 3 can detect voltage at the connection node between the series resistor 31 of the series circuit and the zener diode 32 to detect battery cell 2 voltage. This battery system can detect voltage detection circuit input-side leakage current with a constant voltage circuit having a simple circuit structure.

The discharge circuits 4 of the battery system can form an equalizing circuit 7 that corrects voltage imbalance in the series-connected battery cells 2. In this battery system, since the equalizing circuit is used to determine whether or not battery cell voltage is correctly input to the voltage detection circuit, it is unnecessary to provide a special-purpose circuit to measure battery cell discharge voltage. Consequently, battery cell discharge voltage can be detected with a simple circuit structure.

The decision circuit 35 of the battery system can control the discharge switches 16 of the discharge circuits 4 to detect battery cell 2 discharge voltage. In this battery system, since the discharge switches are controlled by the decision circuit, whether or not the voltage detection circuit operates properly can be detected with optimal timing. For example, in a battery system used as a car power source apparatus, when the ignition switch is turned ON, the decision circuit can switch ON discharge switches to detect discharge voltage. In this case, each time the ignition switch is turned ON, voltage detection circuit operation can be checked for proper operation.

The battery system battery cells 2 can be lithium ion batteries or lithium polymer batteries.

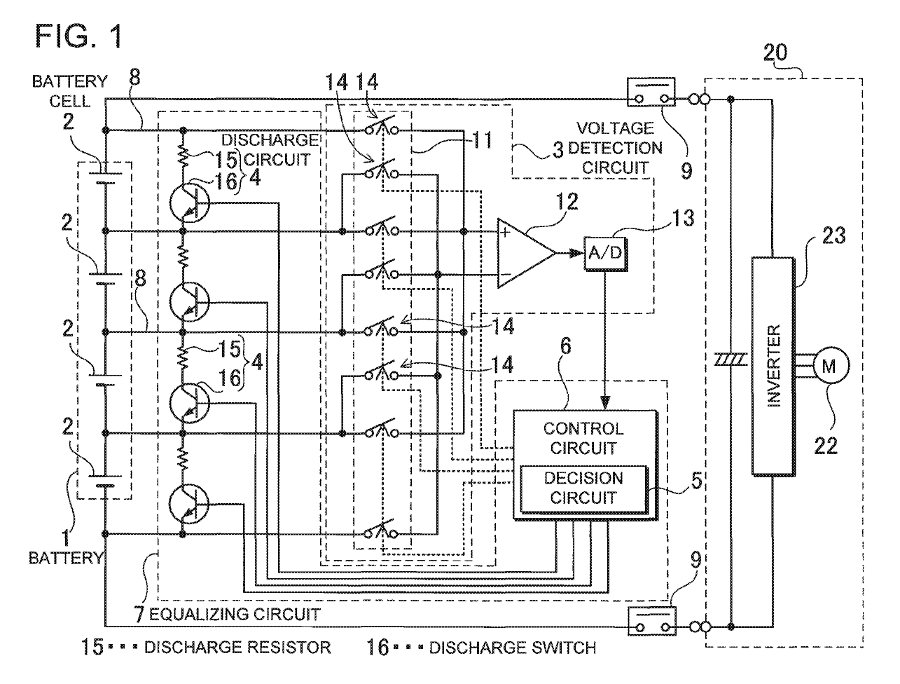

The following describes an embodiment of the present invention. The battery system shown in FIG. 1 is installed on board a vehicle such as a hybrid car, electric automobile, or fuel cell vehicle, and powers a connected motor 22 as its load 20 to drive the vehicle. The motor 22, which is the battery 1 load 20, is connected to the battery 1 through an inverter 23. The inverter 23 converts battery 1 direct current (DC) to three-phase alternating current (AC), and controls power supplied to the motor 22.

The battery system of FIG. 1 is provided with a battery 1 having a plurality of series-connected battery cells 2 that can be recharged, a voltage detection circuit 3 that detects the voltage of each battery cell 2 that makes up the battery 1, discharge circuits 4 that discharge each battery cell 2, and a decision circuit 5 that compares battery cell 2 discharge voltage measured by the voltage detection circuit 3 with the battery cell 2 discharged by the discharge circuit 4 and judges the condition of the connection between the battery cell 2 and the voltage detection circuit 3.

The battery 1 supplies power to the vehicle-side inverter 23 through contactors 9, and the inverter 23 supplies power to the motor 22. To supply high power to the motor 22, the battery 1 has many rechargeable battery cells 2 connected in series to increase the output voltage. Battery cells 2 are lithium ion or lithium polymer batteries. However, any batteries that can be recharged such as nickel hydride batteries can be used as battery cells. A battery system with lithium ion or lithium polymer battery cells has a plurality of lithium ion batteries connected in series. A battery system with nickel hydride batteries has a plurality of nickel hydride batteries connected in series as a battery cell, and then has a plurality of battery cells connected in series to increase output voltage.

To enable high power to be supplied to the motor 22, the battery 1 output voltage is made high. For example, battery 1 output voltage can be 100V to 400V. However, battery system battery voltage can also be raised (for example, by a power converter) to supply power to the load. In this type of battery system, the number of batteries connected in series can be reduced and the battery output voltage can be lowered.

The voltage detection circuit 3 detects the voltage of each battery cell 2. The voltage detection circuit 3 of a battery system with lithium ion batteries detects the voltage of each lithium ion battery. The voltage detection circuit of a battery system with nickel hydride batteries detects the voltages of battery cells that have a plurality of nickel hydride batteries connected in series.

The voltage detection circuit 3 of the figures is connected to the positive and negative electrode terminals of each battery cell 2 via wire-leads 8. One end of each wire-lead 8 is connected to a battery cell 2 electrode terminal via a connecting terminal (not illustrated) or via a connector. The connecting terminal is attached to a battery cell 2 electrode terminal by a set screw. The other end of each wire-lead 8 is solder-attached to a circuit board (not illustrated) implementing the voltage detection circuit 3. However, the other end of each wire-lead can also be connected to the circuit board implementing the voltage detection circuit by a connector.

The voltage detection circuit 3 is provided with a switching circuit 11 that switches the battery cell 2 for voltage detection, a difference amplifier 12 that inputs voltage from the switching circuit 11, and an analog-to-digital (A/D) converter 13 connected to the output-side of the difference amplifier 12.

The switching circuit 11 consecutively inputs the voltage of each battery cell 2 to the input-side of the difference amplifier 12 via switching devices 14. The switching devices 14 are connected to the input-side of the voltage detection circuit 3, and switch the positive and negative electrode terminals of each battery cell 2. A pair of switching devices 14 connected to the positive and negative electrode terminals of each battery cell 2 are switched ON to input the voltage of each battery cell 2 to the difference amplifier 12. With one pair of switching devices 14 in the ON state and all other switching devices 14 OFF, only the voltage of the battery cell 2 connected to the ON-state switching devices 14 is input to the difference amplifier 12. The switching devices 14 connected to the positive and negative electrode terminals of each battery cell 2 are consecutively switched ON to input the voltage of each battery cell 2 to the difference amplifier 12. The switching devices 14 are controlled ON and OFF by a control circuit 6 that houses the decision circuit 5.

The difference amplifier 12 outputs the amplified input voltage difference between the positive and negative input terminals. The difference amplifier 12 amplifies the input battery cell 2 voltage to a valid A/D converter 13 input voltage. In the case where the A/D converter 13 input voltage range is greater than the detected battery cell 2 voltage range, the difference amplifier 12 amplifies the input battery cell 2 voltage and outputs it to the A/D converter 13. The ND converter 13 converts the analog voltage signal input from the difference amplifier 12 to a digital output signal.

A discharge circuit 4 is a series connection of a discharge resistor 15 and a discharge switch 16, and is connected in parallel with a battery cell 2. In a battery system provided with an equalizing circuit 7 that discharges battery cells 2 to correct voltage imbalance, the equalizing circuit 7 can serve additionally as the discharge circuits 4. In this battery system, it is unnecessary to provide special-purpose discharge circuits to detect abnormal connection between the battery cells 2 and the voltage detection circuit 3, and abnormal connection can be detected with a simple circuit structure. In a battery system with no equalizing circuit, or even in a battery system with an equalizing circuit, special-purpose discharge circuits can be provided to detect abnormal connection between battery cells and the voltage detection circuit.

The discharge resistor 15 of a discharge circuit 4 is a resistor to discharge a battery cell 2. In a discharge circuit 4 that serves additionally as part of an equalizing circuit 7, the discharge resistance is set from 100Ω to 300Ω. However, the electrical resistance of the discharge resistor can also be set from 10Ω to 1000Ω. In particular, for a discharge circuit that is not part of an equalizing circuit, the discharge resistance can be set low for more accurate judgment of an abnormal connection. Discharge current can be increased by reducing the electrical resistance of the discharge resistor 15. However, since discharge resistor 15 power consumption is inversely proportional to the electrical resistance, power consumption and the amount of heat generated become large as the electrical resistance is reduced. Therefore, for a discharge resistor 15 that is part of an equalizing circuit 7, an optimum resistance value is set considering battery cell 2 discharge current and heat generation. For a discharge resistor that is not part of an equalizing circuit, the time that the discharge switch is ON can be shortened to reduce total heat generation and allow a low discharge resistance.

A discharge switch 16 is a semiconductor switching device such as a bipolar transistor or field effect transistor (FET). A discharge switch 16 is switched ON to discharge the battery cell 2 connected in parallel with that discharge circuit 4. For a discharge circuit 4 that is part of an equalizing circuit 7, the discharge switch 16 connected in parallel with a battery cell 2 having a high voltage is switched ON to discharge the battery cell 2, reduce its voltage, and equalize battery cell 2 voltages. Consequently, the discharge switches 16 of discharge circuits 4 in an equalizing circuit 7 are controlled by the control circuit 6. Based on the voltage of each battery cell 2, the control circuit 6 switches ON the discharge switches 16 of discharge circuits 4 in parallel with high voltage battery cells 2 to discharge those battery cells 2, reduce their voltages, and correct battery cell 2 imbalance.

Discharge switches 16 of the discharge circuits 4 are switched ON in accordance with timing for judging abnormal connection between the battery cells 2 and the voltage detection circuit 3. To check for abnormal connection between all battery cells 2 and the voltage detection circuit 3, battery cells 2 are consecutively discharged by their discharge circuits 4, and the condition of the connections are detected during those discharge times. Consequently, for discharge circuits 4 that also serve as an equalizing circuit 7, discharge switches 16 are controlled ON and OFF in accordance with timing for correcting battery cell 2 voltage imbalance. In addition, discharge switches 16 are controlled ON and OFF in accordance with timing for judging abnormal connection between the battery cells 2 and the voltage detection circuit 3. Since battery cell 2 discharge time for detection of abnormal connection can be very short, for example, 10 msec, the period for switching a discharge switch 16 ON to detect abnormal connection can be short. Therefore, discharged battery capacity to detect the condition of the connection between battery cells 2 and the voltage detection circuit 3 can be extremely small.

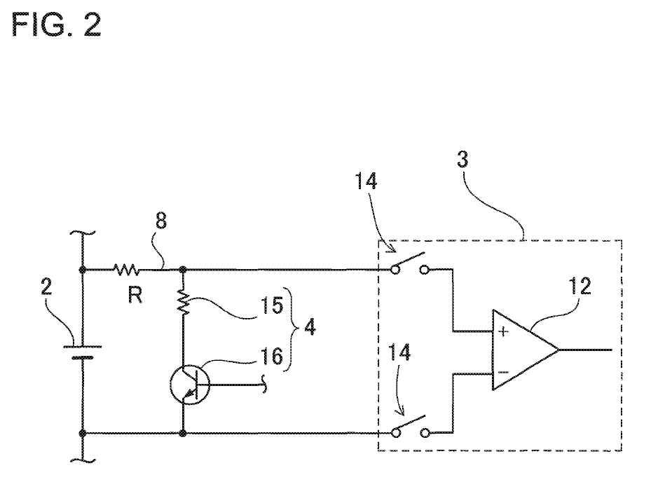

The decision circuit 5 judges abnormal connection between a battery cell 2 and the voltage detection circuit 3 from the difference between the non-discharge voltage and the discharge voltage, or from the discharge voltage of the battery cell 2. FIG. 2 is a circuit diagram showing contact resistance (R) at the connection region of a wire-lead 8 to a battery cell 2. The voltage drop across the contact resistance (R) is proportional to the product of the contact resistance (R) and the current flow. Consequently, the contact resistance (R) voltage drop becomes large when the current is large. When the discharge switch 16 is OFF, current flow through the contact resistance (R) is small. This is because the input impedance of the voltage detection circuit 4 is large. Therefore, the contact resistance (R) voltage drop is small with the discharge switch 16 in the OFF state, battery cell 2 voltage drops only slightly, and this voltage is detected as the non-discharge voltage. Because the contact resistance (R) voltage drop is small, the contact resistance (R) voltage drop and the battery cell 2 voltage drop cannot be discerned from the non-discharge voltage.

When a discharge switch 16 is switched ON, the associated battery cell 2 is discharged. In this state, the discharge current of the battery cell 2 becomes particularly large. This is because the value of the discharge resistor 15 is extremely small compared to the input impedance of the voltage detection circuit 3. For example, if the discharge resistor 15 is 100Ω and the voltage detection circuit 3 input impedance is 100 kΩ, the value of the discharge resistor 15 is only 1/1000 of the value of the input impedance. Consequently, the discharge current is large and voltage drop due to the contact resistance (R) becomes large. For example, if the discharge resistor 15 is 100Ω and the contact resistance (R) is 2 kΩ, the voltage input to the voltage detection circuit 3 is the voltage divided value of approximately 1/20 of the battery cell 2 voltage. If the battery cell 2 voltage varies within a range of 2V to 4V, the voltage input to the voltage detection circuit 3 is reduced to 0.1V to 0.2V.

With the discharge switch 16 OFF, the non-discharge voltage detected by the voltage detection circuit 3 is essentially equal to the battery cell 2 voltage. This is because current flow through the contact resistance (R) is small and the voltage drop due to the contact resistance (R) is extremely small. Here, if the discharge switch 16 is switched ON to detect battery cell 2 discharge voltage, the detected discharge voltage will drop significantly from the non-discharge voltage. This is because current flow through the contact resistance (R) becomes large due to flow through the discharge resistor 15, and contact resistance (R) voltage drop becomes correspondingly large. Consequently, the decision circuit 5 can detect contact resistance (R) from the voltage difference between the non-discharge voltage and the discharge voltage. By determining if the contact resistance (R) voltage drop is greater than a prescribed value, the decision circuit 5 can judge abnormal connection between the battery cell 2 and the voltage detection circuit 3.

Therefore, the decision circuit 5 switches the discharge switch 16 from OFF to ON, and judges abnormal connection between the battery cell 2 and the voltage detection circuit 3 from the difference between the non-discharge voltage and the discharge voltage. The voltage detection circuit 3 detects battery cell 2 non-discharge voltage with the discharge switch 16 in the OFF state, detects battery cell 2 discharge voltage with the discharge switch 16 switched ON, and outputs the detected voltages to the decision circuit 5. The decision circuit 5 compares the voltage difference between the non-discharge voltage and discharge voltage of the battery cell detected by the voltage detection circuit 3 with the normal voltage, and judges abnormal connection for a voltage difference greater than the normal voltage. This is because the voltage difference is equivalent to the voltage drop due to the contact resistance (R). Since the contact resistance (R) voltage drop, which corresponds to the voltage difference, increases in proportion to the contact resistance (R), a large voltage difference indicates a large contact resistance (R) and is judged as an abnormal connection. Here, the normal voltage is set lower than the minimum battery cell 2 voltage. For example, for a battery system with battery cells 2 that are lithium ion batteries, the normal voltage is set to 1.9V.

The decision circuit 5 can also switch a discharge switch 160N to discharge the associated battery cell 2, and judge abnormal connection from the discharge voltage. This decision circuit 5 compares battery cell 2 discharge voltage detected by the voltage detection circuit 3 with the normal voltage, and judges abnormal connection for discharge voltage less than the normal voltage. Here, the normal voltage is lower than the minimum battery cell 2 voltage and is set depending on the value of contact resistance (R) judged as an abnormal connection. For example, the normal voltage is set to 0.2V. This decision circuit 5 compares the discharge voltage with the normal voltage of 0.2V, and judges abnormal connection for a discharge voltage less than 0.2V. In the situation where battery cell 2 voltage is 2V, contact resistance (R) is 1 kΩ, and the discharge resistor 15 is 100Ω, discharge voltage detected by the voltage detection circuit 3 is approximately 0.2V. Therefore, for the case of a 2V battery cell 2 voltage, a decision circuit 5 with normal voltage set at 0.2V judges abnormal connection for contact resistance (R) greater than 1 kΩ. If the battery cell 2 voltage is 4V, abnormal connection is judged for contact resistance (R) greater than 2 kΩ. In a battery system with battery cells 2 that are lithium ion batteries, since battery cell 2 voltage varies within the range of 2V to 4V, the decision circuit 5 can reliably judge abnormal contact resistance greater than 2 kΩ.

Battery cells 2 are consecutively switched for discharge by the control circuit 6, and the decision circuit 5 detects the discharge voltage of each battery cell 2 while it is in the discharging state. The decision circuit 5 judges abnormal connection between each battery cell 2 and the voltage detection circuit 3 by comparing the voltage difference between the non-discharge voltage and the discharge voltage with the normal voltage, or by comparing the discharge voltage with the normal voltage.

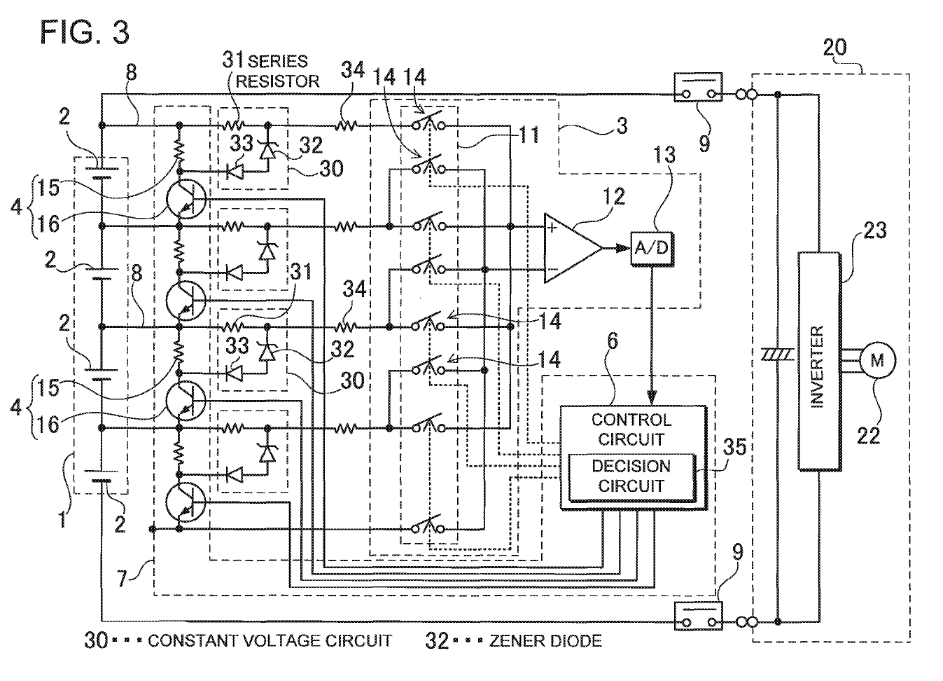

Next, the battery system shown in the circuit diagram of FIG. 3 has constant voltage circuits 30 connected in parallel with discharge resistors 15. In this battery system, battery cell 2 discharge voltage can be detected with the discharge switch 15 in the ON state, and voltage detection circuit 3 input-side leakage current, namely reduction in the input isolation resistance, can be detected.

A constant voltage circuit 30 is a series resistor 31 connected in series with a zener diode 32. The constant voltage circuits 30 of the figures have diode 33 connected in series with the zener diode 32 to prevent reverse current flow. This diode 32 can also serves to save power. The series resistor 31 is connected between a battery cell 2 and the input-side of the voltage detection circuit 3. Further, the battery system of the figures has an input resistor 34 connected between the series resistor 31 and the input-side of the voltage detection circuit 3. The series connection of the series resistor 31 and zener diode 32 that implement a constant voltage circuit 30 is connected in parallel with the discharge resistor 15 of a discharge circuit 4. The zener voltage of the zener diodes 32 is set lower than the minimum battery cell 2 voltage.

In the battery system of FIG. 3, in addition to abnormal connection between a battery cell 2 and the voltage detection circuit 3, voltage detection circuit 3 input-side leakage current can also be detected with the decision circuit 35. The decision circuit 35 judges voltage detection circuit 3 input-side leakage current from the discharge voltage detected by the voltage detection circuit 3. For the battery system of the figures with sufficiently small contact resistance (R) and no voltage detection circuit input-side leakage current, the discharge voltage is essentially the zener voltage. Specifically, as a result of the constant voltage circuit 30, battery cell 2 discharge voltage becomes a voltage that is within a stabilized voltage range. This is because the constant voltage circuit 30 is connected to the positive and negative input terminals of the voltage detection circuit 3 through the ON state discharge switch 16. More accurately, battery cell 2 discharge voltage detected by the voltage detection circuit 3 is the sum of the zener diode voltage, the diode voltage, and the discharge switch 16 transistor collector-emitter voltage.

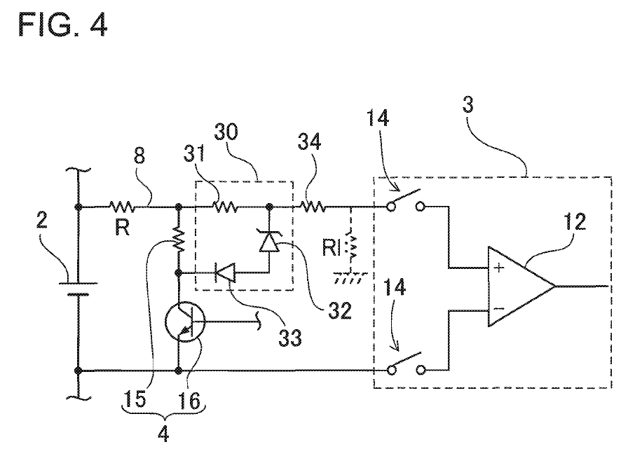

In contrast to the conditions described above, if there is leakage at the input-side of the voltage detection circuit 3 and a leakage resistance (RI) is connected as shown by the broken line in FIG. 4, leakage current flows through the leakage resistance (RI), a voltage drop develops across the input resistor 34, and the detected voltage takes on a value outside the stabilized voltage range of the constant voltage circuit 30. Consequently, if there is leakage in the input-side of the voltage detection circuit 3, the discharge voltage detected by the voltage detection circuit 3 becomes lower than the stabilized voltage of the constant voltage circuit 30, which is essentially the zener voltage. Even in the case where the leakage resistance (RI) connects to a potential that is more positive than the battery cell 2 voltage, voltage detection circuit 3 input voltage will exceed the upper limit of the stabilized voltage range, and it is possible to judge a circuit abnormality.

Further, in a case where no leakage current is generated at the input-side of the voltage detection circuit 3, contact resistance (R) voltage drop will increase if the contact resistance (R) becomes large. If the contact resistance (R) voltage drop becomes large, the voltage supplied to the constant voltage circuit 30, which is the voltage at the connection node between the discharge resistor 15 and the series resistor 31 in FIG. 4, will decrease below the stabilized voltage, which is the zener voltage. The series connection of the series resistor 31 and zener diode 32, which is the constant voltage circuit 30, is a circuit that reduces the supplied voltage to maintain a constant output voltage (stabilized voltage). If the supplied voltage drops below the stabilized voltage, the output voltage of the constant voltage circuit 30 becomes lower than the stabilized voltage. Consequently, the voltage input to the voltage detection circuit 3 drops below the zener voltage, which is the stabilized voltage.

As described above, if there is either leakage in the input-side of the voltage detection circuit 3 or abnormal connection between the battery cell 2 and the voltage detection circuit 3, the discharge voltage detected by the voltage detection circuit 3 will become a voltage that is outside the stabilized zener voltage range. Therefore, if the discharge voltage detected by the voltage detection circuit 3 is outside the stabilized voltage range, the decision circuit 35 judges that there is either voltage detection circuit 3 input-side leakage or abnormal connection between the battery cell 2 and the voltage detection circuit 3.

The stabilized voltage of the constant voltage circuit 30, namely the zener voltage, is set lower than the minimum battery cell 2 voltage. Consequently, even when battery cell 2 voltage drops to its minimum value, discharge voltage detected by a properly operating voltage detection circuit 3 will be the stabilized zener voltage. Here, a properly operating voltage detection circuit 3 can correctly detect battery cell 2 voltage, and has no input-side leakage or abnormal connection between the battery cell 2 and the voltage detection circuit 3. Therefore, in the battery system of FIG. 3, a discharge switch 16 is switched ON, the discharge voltage of the battery cell 2 connected to the ON discharge switch 16 is detected, and from this discharge voltage the decision circuit 35 judges if the voltage detection circuit 3 is operating properly or not. As a result, the battery system can confirm that the voltage detection circuit 3 can correctly detect accurate battery cell 2 voltage, and the battery system can accurately detect the battery cell 2 voltage.

In a battery system used as a car power source apparatus, discharge switches 16 can be switched ON each time the ignition switch is turned ON, it can be confirmed that the voltage detection circuit 3 can correctly detect battery cell 2 voltage, and battery cell 2 voltages can be accurately detected.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims.

The present application is based on Application No. 2008-301744 filed in Japan on Nov. 26, 2008, the content of which is incorporated herein by reference.

What is claimed is:

1. A battery system comprising:
a battery having a plurality of series-connected battery cells that can be recharged;
a voltage detection circuit that detects the voltage of each battery cell;
a discharge circuit connected to each battery cell to discharge each battery cell; and
a decision circuit that judges the condition of the connection between a battery cell and the voltage detection circuit from the detected battery cell voltage measured by the voltage detection circuit;
wherein the voltage detection circuit measures discharge voltage of a battery cell with the discharge circuit in the discharging state, and it measures non-discharge voltage with the battery cell in a non-discharging state; and the decision circuit compares the difference between the detected battery cell non-discharge voltage and discharge voltage with the normal voltage to judge abnormal connection between the battery cell and the voltage detection circuit.

2. The battery system as cited in claim 1 wherein the normal voltage that the decision circuit compares with the difference between the non-discharge voltage and the discharge voltage is set lower than the minimum battery cell voltage.

3. The battery system as cited in claim 1 wherein the discharge circuits are an equalizing circuit that corrects voltage imbalance in the series-connected battery cells.

4. The battery system as cited in claim 1 wherein each discharge circuit is provided with a series-connected discharge resistor and discharge switch.

5. The battery system as cited in claim 4 wherein the decision circuit controls the discharge switch of each discharge circuit to detect battery cell discharge voltage.

6. The battery system as cited in claim 1 wherein the battery cells are either lithium ion batteries or lithium polymer batteries.

7. A battery system comprising:
a battery having a plurality of series-connected battery cells that can be recharged;
a voltage detection circuit that detects the voltage of each battery cell;
a discharge circuit connected to each battery cell to discharge each battery cell; and
a decision circuit that judges the condition of the connection between a battery cell and the voltage detection circuit from the detected battery cell voltage measured by the voltage detection circuit;
wherein the voltage detection circuit measures discharge voltage of a battery cell with the discharge circuit in the discharging state, and the decision circuit compares the detected battery cell discharge voltage with the normal voltage to judge abnormal connection between the battery cell and the voltage detection circuit.

8. The battery system as cited in claim 7 wherein the discharge circuits are an equalizing circuit that corrects voltage imbalance in the series-connected battery cells.

9. The battery system as cited in claim 7 wherein each discharge circuit is provided with a series-connected discharge resistor and discharge switch.

10. The battery system as cited in claim 9 wherein the decision circuit controls the discharge switch of each discharge circuit to detect battery cell discharge voltage.

11. The battery system as cited in claim 7 wherein the battery cells are either lithium ion batteries or lithium polymer batteries.

12. A battery system comprising:
a battery having a plurality of series-connected battery cells that can be recharged;
a voltage detection circuit that detects the voltage of each battery cell;
a discharge circuit made up of a series-connected discharge resistor and discharge switch connected to each battery cell to discharge each battery cell;
a constant voltage circuit connected in parallel with the discharge resistor of each discharge circuit; and
a decision circuit that detects the condition of the connection between a battery cell and the voltage detection circuit and the leakage current of the input-side of the voltage detection circuit from the detected battery cell voltage measured by the voltage detection circuit;
wherein the discharge voltage of a battery cell is measured with the discharge switch in the ON state, and the decision circuit determines abnormal detection by the voltage detection circuit from the measured discharge voltage.

13. The battery system as cited in claim 12 wherein abnormal detection by the voltage detection circuit is either abnormal connection between the battery cell and the voltage detection circuit, or voltage detection circuit input-side leakage current, or both.

14. The battery system as cited in claim 12 wherein the decision circuit judges abnormal detection by the voltage detection circuit when the battery cell discharge voltage detected by the voltage detection circuit is lower than, or higher than a prescribed range that includes the stabilized voltage of the constant voltage circuit.

15. The battery system as cited in claim 12 wherein a constant voltage circuit has a series resistor that connects a battery cell to the voltage detection circuit, the constant voltage circuit is a series circuit that connects the series resistor and a zener diode, this series circuit is connected in parallel with the discharge resistor, and the voltage detection circuit detects battery cell voltage at the connection node between the series resistor and the zener diode of the series circuit.

16. The battery system as cited in claim 15 wherein the zener voltage of the zener diode is set lower than the minimum battery cell voltage.

17. The battery system as cited in claim 12 wherein the discharge circuits are an equalizing circuit that corrects voltage imbalance in the series-connected battery cells.

18. The battery system as cited in claim 17 wherein the decision circuit controls the discharge circuits of the equalizing circuit according to battery cell voltages detected by the voltage detection circuit to correct battery cell voltage imbalance.

19. The battery system as cited in claim 12 wherein the battery cells are either lithium ion batteries or lithium polymer batteries.
